(19) United States
(12) Patent Application Publication
(10) Pub. No.: US 2019/0280862 A1
(43) Pub. Date: Sep. 12, 2019

(54) SYSTEM AND METHOD FOR MANAGING ID

(71) Applicant: Identity Strategy Partners, Alexandria, VA (US)

(72) Inventors: Mark CREGO, Springfield, VA (US); Janice KEPHART, Alexandria, VA (US)

(73) Assignee: Identity Strategy Partners, Alexandria, VA (US)

(21) Appl. No.: 16/296,527

(22) Filed: Mar. 8, 2019

Related U.S. Application Data
(60) Provisional application No. 62/640,538, filed on Mar. 8, 2018.

(51) Int. Cl. H04L 9/08; H04L 9/32; H04L 29/06; G06N 20/00

(52) U.S. Cl. CPC H04L 9/0866; H04L 9/0825; G06N 20/00; H04L 63/102; H04L 9/3231

(57) ABSTRACT

A system and a method for managing identifications. Such a system and method may store and verify identities using biometrics, public key infrastructure, optical technology to validate, store, and transfer identity claims and verifications, and machine learning to increase the confidence of verification.

### CROSS-REFERENCE TO RELATED APPLICATIONS

This application claims priority from U.S. Provisional Patent Application No. 62/640,538, filed on Mar. 8, 2018, entitled “IdWallet,” the entire contents of which are hereby incorporated by reference.

### BACKGROUND

The ability for an employer, vendor, government agency or service provider to “Know Your Customer” is often both a legal requirement and a business necessity. Few options exist for open set identification and verification of customer Identities. In today's world, Identity verification is complex, and made more difficult by cyberspace. We have little assurance that we are dealing with a real customer in cyberspace. The cost to prevent identity theft and fraud increases every year. Furthermore, each new employment situation triggers a new round of “E-Verify” documentation and processing, and the employer has the burden of determining if the identification presented by the employee is legitimate. Therefore, advanced method and system are required to solve such a problem.

### SUMMARY

The invention is directed to a system and a method for managing any of a variety of identifications. According to an exemplary embodiment, such a system and method may store and verify identities using biometrics, public key infrastructure, optical technology to validate, store, and transfer identity claims and verifications, and machine learning to increase the confidence of verification.

Such a system may include: a device for managing identifications comprising: one or more optical reader; a display; a processor; and a memory which has corresponding sets of computer instructions stored therein that are executable by the processor to cause the device to perform the functionality described herein including: storing biometric information from a user; authenticating the user to give access to personal information stored in the device; storing at least one identity claim from an identification document; sending a request for the personal information; sending a response to the request; and storing a validation feedback to increase confidence in the validity of identity claims based upon verifications.

In another exemplary embodiment, a method for managing identifications may be described. Such a method may include: storing, by at least one device which includes at least one optical reader, a display, a processor, and memory communicatively coupled to the processor, biometric information from a user; authenticating, by the at least one device, the user to give access to personal information stored in the at least one device; storing, by the at least one device, at least one identity claim from an identification document; sending, by the at least one device, a request for the personal information; sending, by the at least one device, a response to the request; and storing, by the at least one device, a validation feedback on the at least one device.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1A is an exemplary schematic diagram showing a process for managing identifications by recognizing biometric information and converting them into an encrypted hash code;

FIG. 1B is an exemplary schematic diagram for managing identifications by storing an encrypted hash code in a distributed database and feeding the encrypted hash code for machine learning;

FIG. 2A is an exemplary schematic diagram for managing identifications by storing a personal information from identification documents;

FIG. 2B is an exemplary schematic diagram for managing identifications by generating an encrypted hash code of identity claims;

FIG. 2C is an exemplary schematic diagram for managing identifications by storing an encrypted hash code after machine learning;

FIG. 3 is an exemplary schematic diagram for managing identifications by verifying a user with the user's biometric facial information;

FIG. 4A is an exemplary schematic diagram for managing identifications by sending a request by a second device to a first device for verification of a user;

FIG. 4B is an exemplary schematic diagram for managing identifications by handling the second device's request in the form of an optical barcode by the first device;

FIG. 4C is an exemplary schematic diagram for managing identifications by validating a personal information which is sent to an authority by the second device; and

FIG. 4D is an exemplary schematic diagram for managing identifications by storing a validation feedback received by the first device.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring to the Figures generally, a system and a method to store and verify identities using biometrics, PKI (Public Key Infrastructure), and optical technology to validate, store, and transfer identity claims and verifications may be shown and described. According to an exemplary embodiment, such a system and method may contain an individual's identity via live biometrics, government issued identifications, which may include identity claims, and verifications of the government issued identifications. For example, the identity claims may optionally include biometric information, a name, a Social Security number, an address, an email address, a phone number, a date of birth, a place of the birth, a nationality, a citizenship or an immigration status, a passport number, a passport card number, a driver's license number, an expiration date of visa, a type of visa or other claims as would be understood by a person having ordinary skill in the art. Also, in an exemplary embodiment, the system and method may have a self-made identity database that lives virtually on a device, the cloud, or in blockchain in cyberspace, which may be encrypted, secure, and verifiable.

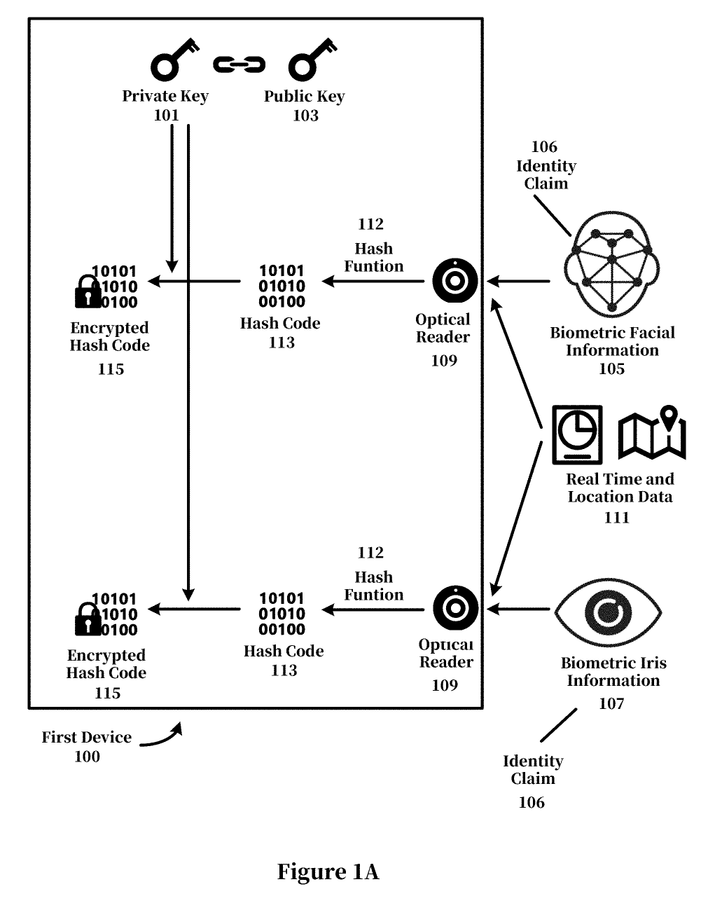

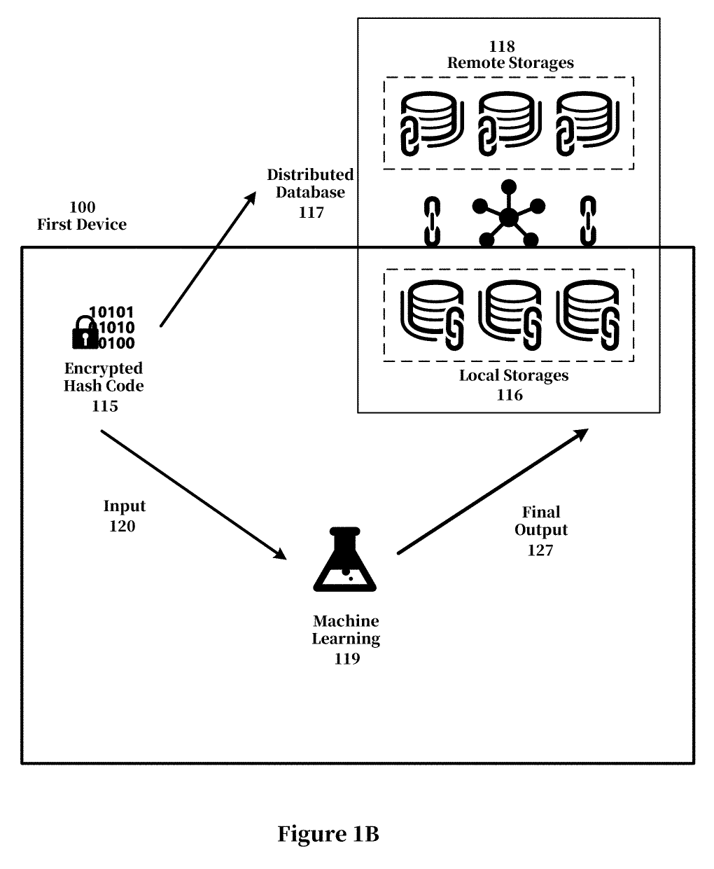

Turning now to exemplary FIG. 1A, an exemplary schematic diagram of the system may show the steps for recognizing biometric information 105, 107 and converting this information into an encrypted hash code 115. According to an exemplary embodiment, a first device 100 may be configured to generate a private key 101 and a public key 103 to be used to encrypt and decrypt the data in the system. Additionally, the first device 100 may use encryption and signing to validate the integrity of prior identity claim 106, and may extend to allow for full local, network independent exchange of validated identity credentials and cascaded identity claims, which may be dependent upon other identity claims. An exemplary cascaded identity claim may be a driver's license number because the issuance of a driver's license depended upon the provision of feeder document credentials, such as a birth certificate, proof of address, and social security number. Also, in an exemplary embodiment, the first device 100 may be populated initially by recognizing biometric data via at least one optical reader 109. The biometric data may be biometric facial information 105 or biometric iris information 107. Additionally, the biometric facial information 105 or the biometric iris information 107 may be converted into a hash code 113 by a hash function 112, and the hash code 113 may be encrypted into the encrypted hash code 115 using the private key 101. Furthermore, the biometric facial information 105 or the biometric iris information 107 may include a record of real time and location data 111 as it is recognized by at least one optical reader 109, and may be rendered as one of the identity claim 106.

Turning now to exemplary FIG. 1B, an exemplary schematic diagram of the system of storing an encrypted hash code 115 in a distributed database 117 and feeding the encrypted hash code 115 for machine learning 119 may be shown and described. According to an exemplary embodiment, biometric facial information 105 or biometric iris information 107 in the encrypted hash code 115 may be stored in a distributed database 117 of the local and remote storages 116, 118. Also, the first device 100 may utilize hierarchal, distributed inheritance of encryption signatures to both store the system across cyberspace and upon mobile devices, while providing a traceback hash to the originators and verifiers of the identity claim 106.

Still referring to exemplary FIG. 1B, the first device 100 may provide for technology that uses artificial intelligence to increase the validity of identity claim 106, by machine learning 119 to increase the confidence of identity verification with each encounter. Accordingly, a user's identity is validated, the validation event and provenance details are fed back to the user's database as secure hash signatures of the evidence presented in the encounter.

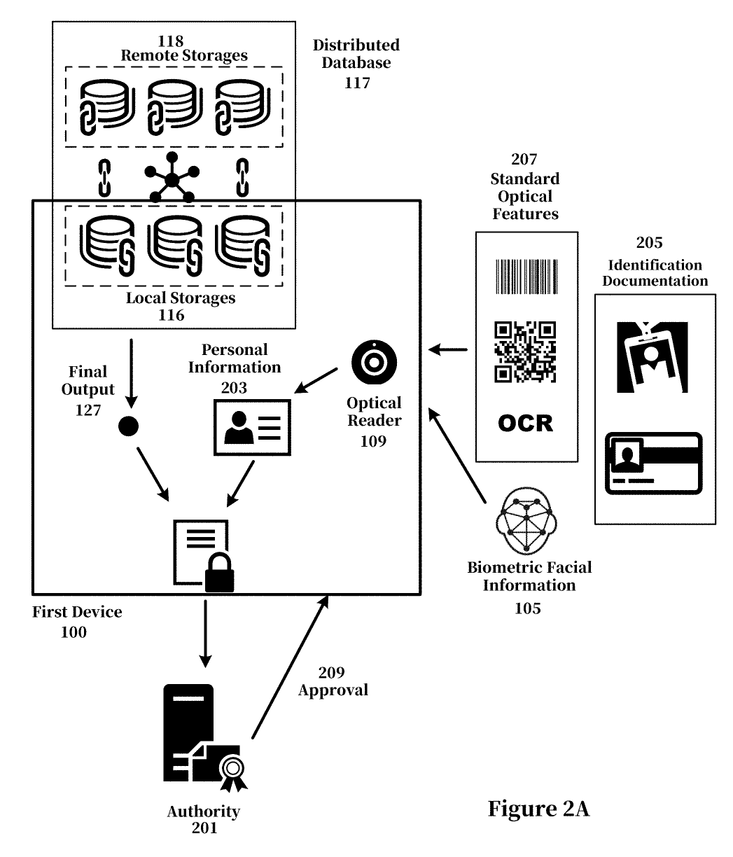

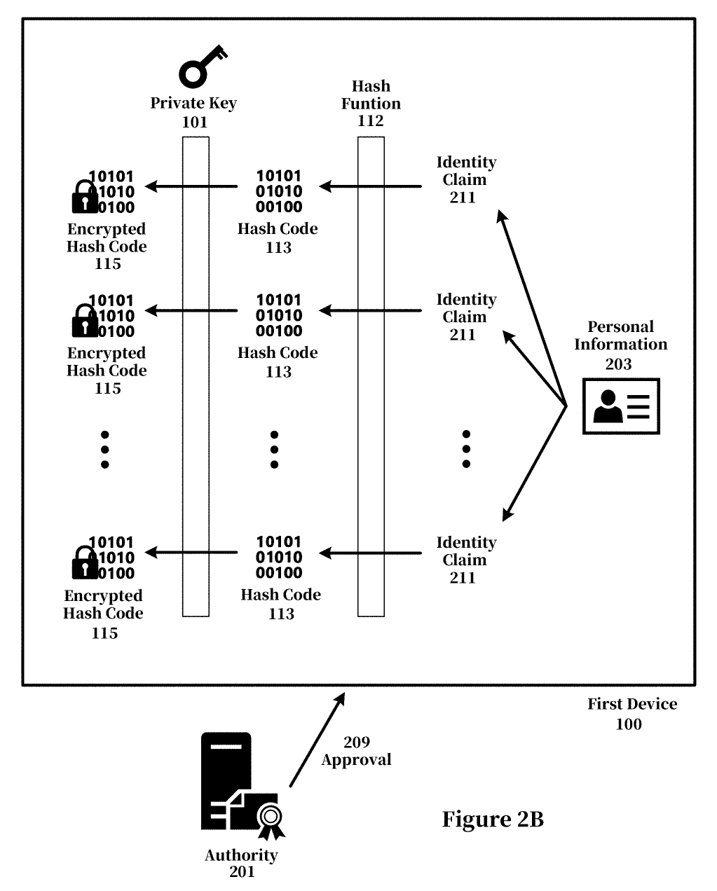

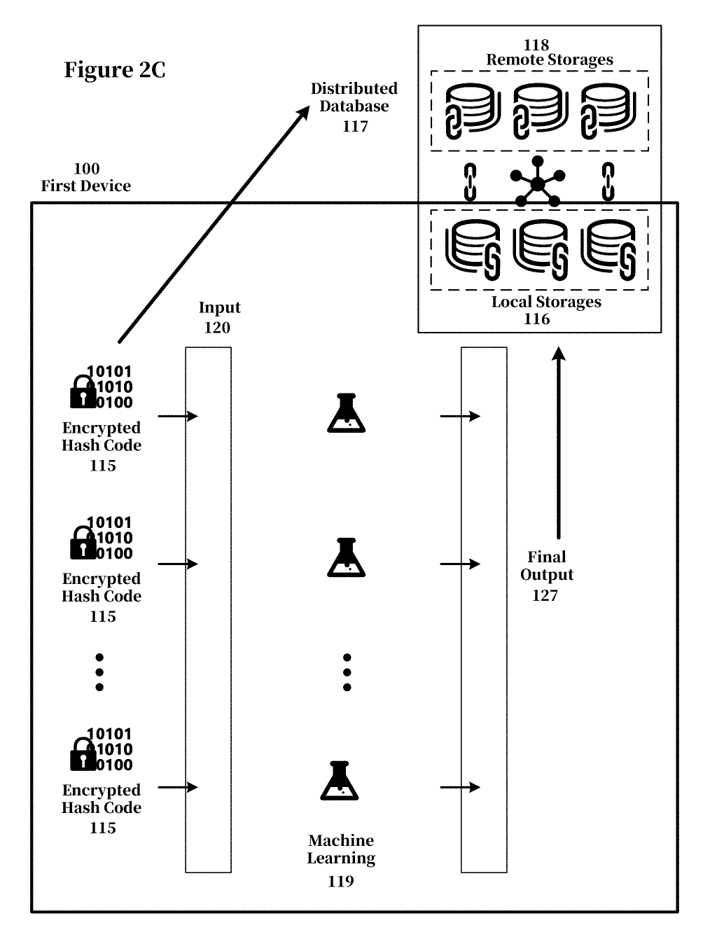

Turning now to exemplary FIG. 2A, an exemplary schematic diagram of the system of storing personal information 203 from identification documents 205 may be shown and described. The identification documents may optionally include, for example, a birth certificate, Social Security card, state-issued driver's license, US passport, foreign passport with 1-551 stamp, passport card, green card, visa, student ID, LPR card, military card, 1-766 Employment Authorization Document, and other identification documents as would be understood by a person having ordinary skill in the art. According to an exemplary embodiment, the first device 100 may be populated initially by a user-friendly ability to scan the identification document 205, recognizing optical features 207 of these documents, as well as lifting biometric information from the identification, where available, in order to validate that a user's face matches the biometric information on the documents. For example, the optical features may include Barcodes, QR codes, Machine Readable Zones, etc. Particularly, in an exemplary embodiment, the personal information is in the form of optical features 207 including optical characters, and the personal information 203 includes the biometric facial information 105, if the biometric facial information 105 is available on the identification document 205. In an exemplary embodiment, the first device 100 may recognize the personal information 203 from the identification document 205 via the at least one optical reader 109 of the first device 100, send a request to an authority 201 in order to receive an approval to store the personal information 203 from the identification document 205 in the distributed database 117 of the first device 100. For example, the authority may include Social Security Administration, State Department, AAMVA (American Association of Motor Vehicle Administrators) or driver license issuing state, USCIS (United States Citizenship and Immigration Services) or any equivalent government organizations, including a combination of the personal information 203 from the identification document 205 and the final output 127 of the biometric information stored in the distributed database 117.

Turning now to exemplary FIG. 2B, an exemplary schematic diagram for generating an encrypted hash code 115 of identity claim 211 may be shown and described. According to an exemplary embodiment, in the response to an approval 209 of the authority 201, each identity claim 211 of the personal information 203 may be separated, converted into a hash code 113 by a hash function 112, and the hash code 113 may be encrypted into an encrypted hash code 115 using a private key 101 generated by the first device 100.

Turning now to exemplary FIG. 2C, an exemplary schematic diagram of the system of sending an encrypted hash code 115 to a machine learning 119 process may be shown and described. According to an exemplary embodiment, each identity claim 211 in the encrypted hash code 115 in FIG. 2B may be stored in the distributed database 117 in local and remote storages, 116, 118, and may be used for machine learning 119 as an input 20 in order to extract the final output 125 of the identity claim 211.

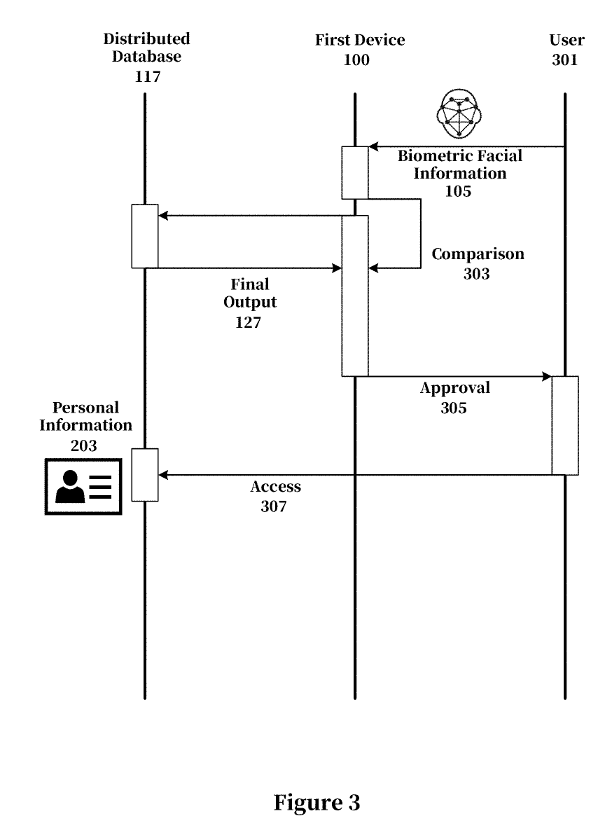

Turning now to exemplary FIG. 3, an exemplary schematic diagram of the system of verifying a user 301 with the user's biometric facial information 105 may be shown and described. According to an exemplary embodiment, when a user attempts to access personal information 203 stored in the distributed database 117 of the first devise 100, the first device 100 may require the user 301 to input the user's biometric information for comparison 303 of the user's input with the one stored in the distributed database 117 of the first device 100. Further, in an exemplary embodiment, if a similarity of the user's biometric facial information 105 and the final output of the biometric facial information 127 stored in the first device 100 reaches a predetermined threshold, the first device 100 may grant the user an approval 305 to access 307 the personal information 203 stored in the first device 100.

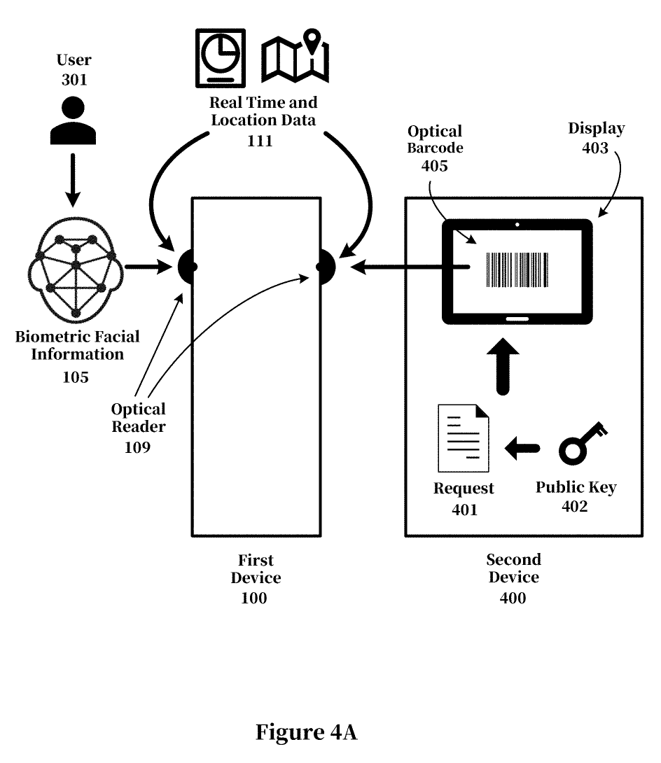

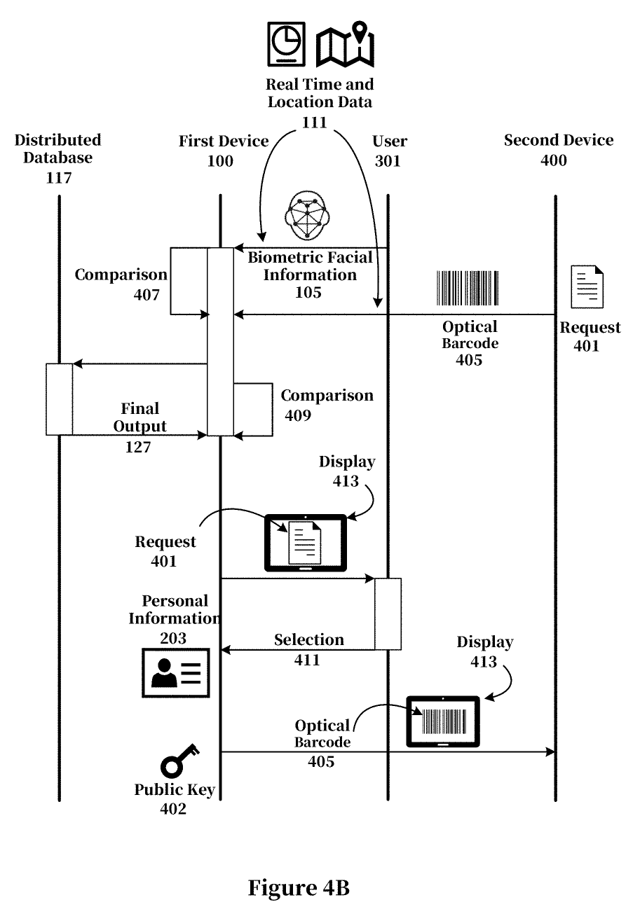

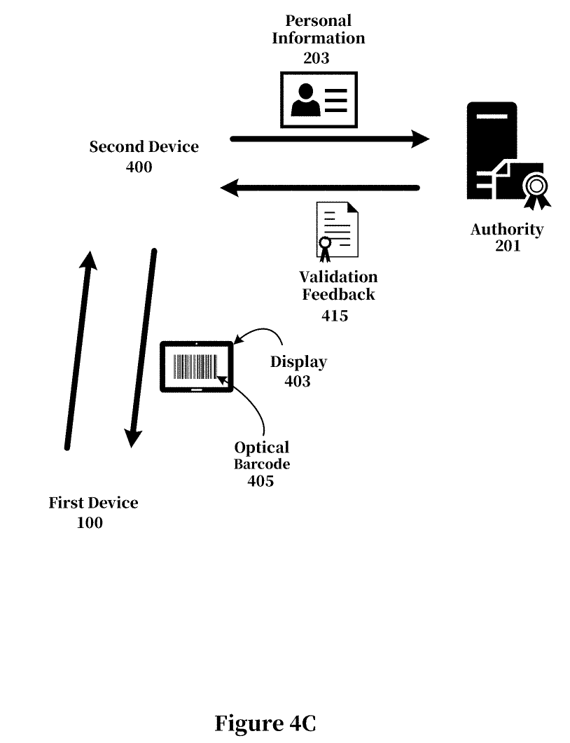

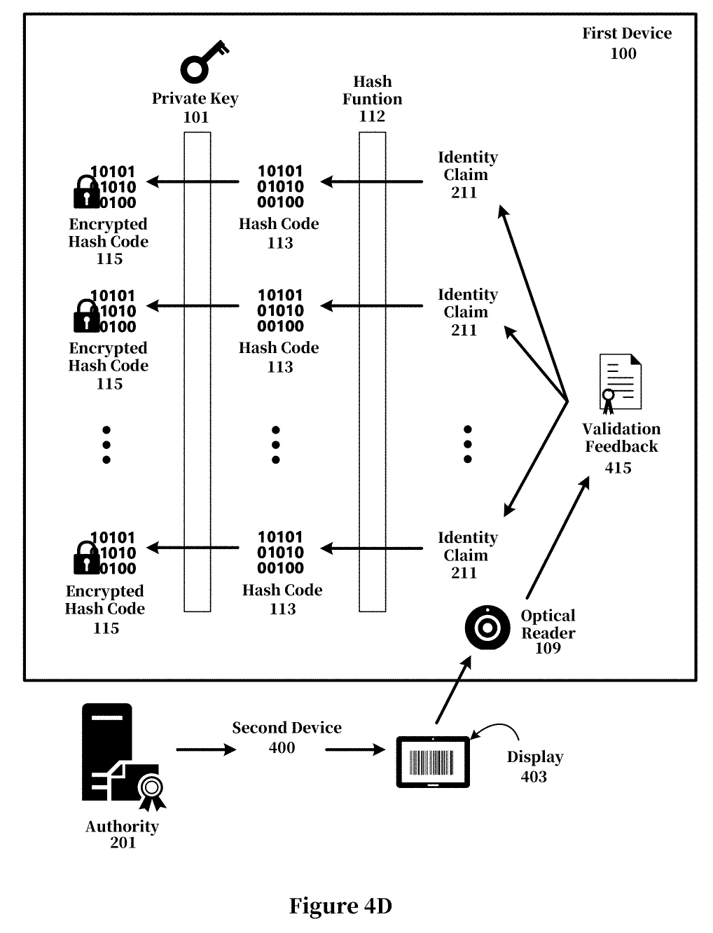

Turning now to exemplary FIG. 4A, an exemplary schematic diagram for sending a request 401 by a second device 400 to the first device 100 may be shown and described. The schematic may also show verification of a user 301. According to an exemplary embodiment, the second device 400 may send a request 401 to the first device 100 to send all or a part of the personal information stored in the first device 100. Additionally, the request 401 may include the second device's public key 402 to be usable by the first device to encrypt the personal information. Furthermore, the request 401 of the second device 400 may be generated in the form of an optical barcode 405 to be shown on its display 403.

Still referring to exemplary FIG. 4A, the first device 100 may receive the request 401 of the second device 400 via one or more optical readers 109 of the first device 100. In an exemplary embodiment, the system may require that the one or more optical readers 109 of the first device 100 may simultaneously recognize a user's biometric facial information 105 and scan a second device's request 401 in the form of an optical barcode 405. Also, in an exemplary embodiment, both the user's biometric facial information 105 and the second device's request 401 in the form of an optical barcode 405 may include real time and location data 111 of the recognition and the scan.

Turning now to exemplary FIG. 4B, an exemplary schematic diagram for handling the second device's 400 request 401 in the form of an optical barcode 405 by the first device 100 may be shown and described. According to an exemplary embodiment, if a difference 407 of the record of real time and location data between the recognized biometric facial information 105 and the scanned request in the form of an optical barcode 405 from the second device 400 is within a predetermined range, the system may then compare the user's 301 biometric facial information 105 and the final output 127 of the biometric facial information stored in the first device 100. Additionally, in the exemplary embodiment, if a similarity of the user's 301 biometric facial information 105 and the final output 127 of the biometric facial information stored in the first device 100 reaches a predetermined threshold, a list of the identity claims from the request 401 of the second device may be shown to the user 301 via the display 413. Furthermore, if the user 301 selects 411 a set of the identity claims from the list, the first device 100 generates a combination of a set of the identity claims and the user's biometric facial information 105. Finally, the combination which may include the record of real time and location data 111 of the user 301's biometric facial information 105 may be encrypted using the second device's public key, and the optical barcode 417 of the encrypted combination for the second device 402 is generated by the first device to be shown on the display 413 of the first device 100.

Turning now to exemplary FIG. 4C, an exemplary schematic diagram for validating a personal information 203 which is sent to an authority 201 by the second device 400 may be shown and described. According to an exemplary embodiment, if an encrypted combination of the first device 100 is received by the second device 400, the second device 400 may send the personal information 203 of the first device 100 to an authority in order to validate the personal information 203 in the encrypted combination. Also, in an exemplary embodiment, the second device 400 may request a validation feedback 415 to the authority 201. Furthermore, if the validation feedback 415 from the authority 201 is received by the second device 400, the validation feedback 415 from the authority 201 may be generated in the form of an optical barcode 405 to be shown on the display 403 of the second device 400, and then the first device 100 may receive the optical barcode 405 from the second device 400.

Turning now to exemplary FIG. 4D, an exemplary schematic diagram for storing a validation feedback 415 received by the first device 100 may be shown and described. According to an exemplary embodiment, if the second device 400 presents the validation feedback 415 via its display 403, the first device 100 may scan and receive the validation feedback 415 via its optical reader 109. Furthermore, in the exemplary embodiment, each of the identity claim 211 of the validation feedback 415 may be separated and converted into an hash code 113, and the hash code 113 may be encrypted into encrypted hash code 115 using the first device's private key. The encrypted hash code 115 may be stored in a distributed database in local and remote storages.

In alternative exemplary embodiments, the system may use the combination of PKI and blockchain technology, along with local database storage and biometrics required to open such storage, a person's privacy is assured, as well as the security of personally identifiable information (PII). Further, in the exemplary embodiments, a person's complete set of identity claims, including the PKI encrypted signing data from authorized agencies, is held under user's control across cyberspace, mobile, and local devices.

In additional exemplary embodiments, the system may use PKI-enabled timestamps within signatures of live biometric data, which may be linked to signatures of prior live verification encounters in order to prove that a live person in situ is the same as the enrolling encounter of a given biometrically enabled document. For example, this may provide assurance to the claim that this person here and now or in situ is exactly the same person as the person who was issued this passport. Therefore, the live situ biometric and the historical certificate from the passport in the system may be thus and then linked together using a third signed hash that contains both the live encounter hash and the passport hash signature. The historical certificate from the passport may be a signing certificate used on an e-passport, assuring that the data on the e-passport chip is valid and issued by the stated issuing country. Data on the e-passport chip may include issuing country, passport number, biographical details, photograph, other biometrics, issuance date, expiration date, and other data, as would be understood by a person having ordinary skill in the art.

In further exemplary embodiments, the system may extend upon the facial matching in specific ways: to increase liveness detection, to use timestamping to assure authenticity of biometric capture, and to use confident non-matching biometric algorithms to reduced false negatives. Liveness detection may include any technique used to detect a spoof attempt by determining whether the source of a biometric sample is a live human being or a fake representation. This may be accomplished through algorithms that analyze data collected from biometric sensors to determine whether the source is live or reproduced. Additionally, the system may include an adaptive, “defense in depth” ability to update the biometric algorithms and approaches in near-real-time in order to reduce spoofing of biometrics. Furthermore, the system may approach facial matching with an extended facial template, including visible and near-infrared illumination in order to capture integrated facial and iris minutiae in order strengthen facial matching where such sensors are present in situ.

Still further, exemplary embodiments may include an ability to drive data into a form from the system's database. The system may extend by focusing on identity data, creating a relationship between the requested form data, and thus enabling the user to agree to the privacy conditions of a form by sharing the data with conscious and active acceptance. Additionally, the system may create individual signatures that may be incorporated into an electronically signed document by inheriting the authentication signature behind a given identity claim. For example, when a person enters in a social security number, the signature of the social security verification event can be incorporated into a signed document proving that the social security administration has validated that the name, place, and date of birth information matches the social security number provided. Furthermore, the signature may then be verified by the Public Key of the Social Security Administration to assure the authenticity of the data.

In still further exemplary embodiments, the system may facilitate local exchange of encrypted data using optical barcodes, such as QR codes with encryption, which may support exchanging encryption signatures across optical local connections, thus providing secure and private transmission of personally identifiable information. Particularly, the system may use optical technology in place of online digital exchange: the user in situ responds to an identity challenge with a responding process, that has a one-time, time and location stamped optical transfer of hash signatures in order to transfer data to the requester.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for managing identifications comprising:
storing biometric information from a user on at least one device comprising at least one optical reader, a display, a processor, and memory communicatively coupled to the processor;
storing at least one identity claim from an identification document;
authenticating a user to access personal information stored on the at least one device;
sending a request for the personal information;
receiving a response to the request; and
storing a validation feedback as one or more inputs for machine learning.

2. The method of claim 1, further comprising generating a private key and public key pair; encrypting the personal information using PKI encryption; and decrypting the personal information using PKI encryption after authentication.

3. The method of claim 1, wherein the biometric information comprises at least one of biometric facial information and biometric iris information.

4. The method of claim 1, further comprising scanning the identification document using the at least one optical reader to generate the at least one identity claim.

5. The method of claim 1, further comprising automatically filling out a request using the at least one identity claim from a distributed database.

6. The method of claim 1, wherein the at least one device is configured to recognize the biometric information via at least one optical reader of the at least one device or to scan the request via at least one optical reader of the at least one device, and the biometric information or the request includes a real time and location data of the recognition or the scan.

7. The method of claim 1, wherein the at least one device is configured to request at least one responding device to respond with all or a part of the personal information stored in the at least one responding device, wherein the request provides the at least one requesting device's public key for the at least one responding device to encrypt the personal information, and wherein the request of the at least one requesting device is generated in the form of an optical barcode to be shown on the display.

8. The method of claim 7, wherein the request of the at least one device is received by the at least one responding device via the at least one optical reader of the at least one responding device, the at least one optical reader of the at least one responding device recognizes user's biometric information and scans the request of the at least one requesting device, the user's biometric information and the final output of the biometric information stored in the at least one responding device are compared in the event that a difference of the real time and location data between the recognized biometric information and the scanned request is within a predetermined range, a list of the at least one identity claim from the request is shown to the user via the display to receive the user's selection in the event that a similarity of the user's biometric information and the final output of the biometric information reaches a predetermined threshold, the at least one responding device generates a combination of the at least one identity claim selected by the user and the user's biometric information, and wherein the optical barcode of the encrypted combination is shown on the display of the at least one responding device.

9. The method of claim 8, wherein the at least one requesting device is configured to send the encrypted combination of the at least one responding device to an authority and request validation feedback from the authority, and wherein the validation feedback from the authority is generated in a form of an optical barcode.

10. A device for managing identifications comprising:
at least one optical reader;
a display;
a processor; and
a memory having computer instructions stored thereon that are executable by the processor to cause the device to perform the steps of:
storing biometric information from a user;
authenticating the user to give access to personal information stored on the device;
storing at least one identity claim from an identification document;
sending a request for the personal information;
receiving a response to the request; and
storing a validation feedback as one or more inputs for machine learning.

11. The device of claim 10, further comprising instructions for generating a private key and public key pair; encrypting the personal information using PKI encryption; and decrypting the personal information using PKI encryption after authentication.

12. The device of claim 10, wherein the biometric information comprises at least one of biometric facial information and biometric iris information.

13. The device of claim 10, further comprising instructions for scanning the identification document using the at least one optical reader to generate the at least one identity claim.

14. The device of claim 10, further comprising instructions for automatically filling out a request using the at least one identity claim from a distributed database.

15. The device of claim 10, wherein the at least one optical reader is configured to recognize the biometric information or to scan the request, and wherein the biometric information or the request includes real time and location data of the recognition or the scan.

16. The device of claim 10, further comprising instructions for requesting at least one responding device to respond with all or a part of the personal information stored in the at least one responding device, wherein the request provides the at least one requesting device's public key for the at least one responding device to encrypt the personal information, and wherein the request of the at least one requesting device is generated in the form of an optical barcode to be shown on the display.
